(19) United States
(12) Patent Application Publication
(10) Pub. No.: US 2021/0191663 A1
(43) Pub. Date: Jun. 24, 2021

(54) MANAGEMENT OF WRITE MODES OF A FILESYSTEM

(71) Applicant: HEWLETT PACKARD ENTERPRISE DEVELOPMENT LP, Houston, TX (US)

(72) Inventors: Matthew Bondurant, Superior, CO (US); Anand Satish Phatak, Bangalore (IN); Smitha Jayaram, Bangalore (IN); Manoj Thankappan Varadamma, Bangalore (IN); Jeong Goo Lee, Andover, MA (US); Nandesh Kumar Palanisamy, Andover, MA (US)

(21) Appl. No.: 16/722,285

(22) Filed: Dec. 20, 2019

(51) Int. Cl. G06F 3/06

(52) U.S. Cl. CPC G06F 3/0665; G06F 3/0644; G06F 3/0608; G06F 3/0679; G06F 3/0652

(57) ABSTRACT

Examples described herein relate to method and system for managing write modes of a filesystem, wherein the filesystem is mapped to a thinly-provisioned virtual volume (TPVV) defined using a common-provisioning group (CPG) of a set of physical storage devices. The filesystem may be operated in a read-write mode. A used storage capacity of the CPG may be monitored when the filesystem is operational in the read-write mode. Further, a check may be performed to determine whether the used storage capacity of the CPG has reached a storage fullness threshold value. Accordingly, if it is determined that the used storage capacity of the CPG has reached the storage fullness threshold value, the filesystem may be transitioned to a partial read-only mode from the read-write mode.

### BACKGROUND

Storage systems may be implemented as converged systems or hyper-converged systems. In some example converged or hyper-converged storage systems, physical storage media, such as, storage disks and/or solid-state drive (SSD) memory devices, may be abstracted and virtual volumes may be exposed to a file management system. The file management system may in-turn manage and control file operations such as, but not limited to, various write operations and read operations on the virtual volumes.

### BRIEF DESCRIPTION OF THE DRAWINGS

These and other features, aspects, and advantages of the present specification will become better understood when the following detailed description is read with reference to the accompanying drawings in which like characters represent like parts throughout the drawings, wherein:

FIG. 1 illustrates a system including a management system for a storage system, in accordance with an example;

FIG. 2 is a flow diagram depicting a method for managing write modes of a filesystem, in accordance with an example;

FIG. 3 is a flow diagram depicting a detailed method for managing write modes of a filesystem, in accordance with another example;

FIG. 4 is a flow diagram depicting a method for managing write modes of a filesystem, in accordance with an example;

FIG. 5 is a block diagram depicting a processing resource and a machine-readable medium encoded with example instructions to manage write modes of a filesystem, in accordance with an example; and

FIG. 6 is a block diagram depicting a processing resource and a machine-readable medium encoded with example instructions to manage write modes of a filesystem, in accordance with an example.

It is emphasized that, in the drawings, various features are not drawn to scale. In fact, in the drawings, the dimensions of the various features have been arbitrarily increased or reduced for clarity of discussion.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, etc., may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

In some example converged or hyper-converged storage systems, physical storage media, such as, storage disks and/or solid-state drive (SSD) memory devices, may be abstracted and virtual volumes may be exposed to a file management system. The file management system may in-turn manage and control file operations such as, but not limited to, various write operations and read operations on the virtual volumes. By way of example, a typical virtual storage system may include one or more physical storage devices, for example, storage disks and/or solid-state drives. The physical storage devices may be disposed in a common enclosure or may be disposed at remote locations from each other and may be coupled to each other via a communication network. The physical storage devices may be divided into chunklets. Each chunklet may occupy physically contiguous space on a physical storage device.

Further, one or more logical disks may be created from groups of chunklets. In particular, in a logical disk, the chunklets may be arranged as rows of RAID sets. Furthermore, the logical disks may be pooled together in a common provisioning group (CPG). The CPG is a template for creating logical disks that allocate space to virtual volumes on demand. Several virtual volumes may be created using a storage space defined by the CPG. Examples of the virtual volumes that can be created using the CPG may include, but are not limited to, a fully-provisioned virtual volume (FPVV) and a thinly-provisioned virtual volume (TRVV). An FPVV of a predetermined fixed storage size, when created, may occupy the predetermined fixed storage size from the CPG immediately upon creation. Whereas, a TPVV of a specific storage size, when created, may not occupy the specific storage space upon creation. In fact, a storage space may be allocated to such TRVV as needed based on utilization of such TRVV.

A virtual volume defined using the CPG may be exposed to file management systems as a Logical Unit Numbers (LUN). The file management system may facilitate file management operations and may allow clients to access the virtual volume for various file storage applications using one or more file access protocols, such as, Server Message Block (SMB), Network File system (NFS), and File Transfer Protocol (FTP), and Object Access API protocols such as Representational State Transfer (REST) Application Programming Interface (API). To provide such access to the virtual volume, the file management system may implement one or more of a filesystem, Virtual File Server (VFS), File Stores (FS), and File Shares.

The filesystem may control how files are stored and retrieved from an underlying virtual volume (e.g., FPVV or TPVV). The filesystem may be transparently constructed from one or multiple virtual volumes and may be a unit for replication and disaster recovery for the file management system. The VFS may be a server which presents virtual IP addresses to clients, participates in user authentication services and may have properties for user or group quota management, file lock policies, and/or antivirus policies. Certain file management tasks and policy decisions may be made at the VFS level. Further, the FS may represent a slice of the VFS and filesystem at which snapshots may be taken, capacity quota management may be performed, and file lock policies and antivirus scan service policies may be customized. File shares may provide file level access to the clients via file access protocols, e.g., SMB, NFS, FTP, REST API, subject to the share permissions applied to them. Multiple file shares may be created in a given file store and at different directory levels within the given file store.

In certain configurations of file management systems, a filesystem may be defined using a TPVV. In such file management systems defined using the TPVV, the clients accessing the file management system may not have visibility of a used capacity of the underlying CPG. In traditional approaches, when the underlying CPG runs-out of storage space, alerts may be issued to the clients and the filesystem may be deactivated (e.g., transitioned to a read-only mode). Typically, in the read-only mode no operation other than merely viewing the files may be permitted. While such deactivation of the filesystem may ensure data consistency, it may result in Data Unavailability (DU) for the file shares exported from such deactivated filesystem.

In order to overcome such DU events, in accordance with aspects of the present disclosure, a method for dynamically adapting write modes of a filesystem mapped to a TPVV is presented. For example, during normal operation (i.e., when the CPG is not full), the filesystem may be operated in a read-write mode which may allow various file management operations that can consume and/or free-up space from the CPG. In some examples, a used storage capacity of the CPG may be monitored when the filesystem is operational in a read-write mode. Further, a check may be performed to determine whether the used storage capacity of the CPG has reached a storage fullness threshold value. In some examples, the storage fullness threshold value may be indicative of a storage capacity equal to a total storage capacity of the CPG. In certain examples, the storage fullness threshold value may be indicative of a storage capacity that is substantially close to the total storage capacity of the CPG. In one example, the term “substantially close to” may refer to being within 20% of the total storage capacity. In another example, the term “substantially close to” may refer to being less than the total storage capacity by a predetermined storage capacity. The predetermined storage capacity may be defined by a user or preconfigured.

In response to determining that the used storage capacity of the CPG has reached the storage fullness threshold value, the filesystem may be transitioned to a partial read-only mode from the read-write mode. In the partial read-only mode, in accordance with aspects of the present disclosure, file management operations that use additional storage space may be disabled, however, a user initiated file management operation that frees up at least a portion of storage space from the CPG may be allowed in the filesystem.

As will be appreciated, by permitting the user initiated file management operations, for example, a file delete operation, an operation to delete data within a file, a truncate operation, etc. any unused and/or redundant data as determined by the user may be deleted and at least some portion of the storage space from the CPG may be made available. Advantageously, this helps in avoiding DU to file shares; and will also allow individual share users to free up space and optimize the usage of storage space. Once, certain amount of storage space is made available in the CPG, the filesystem may again be transitioned to the read-write mode.

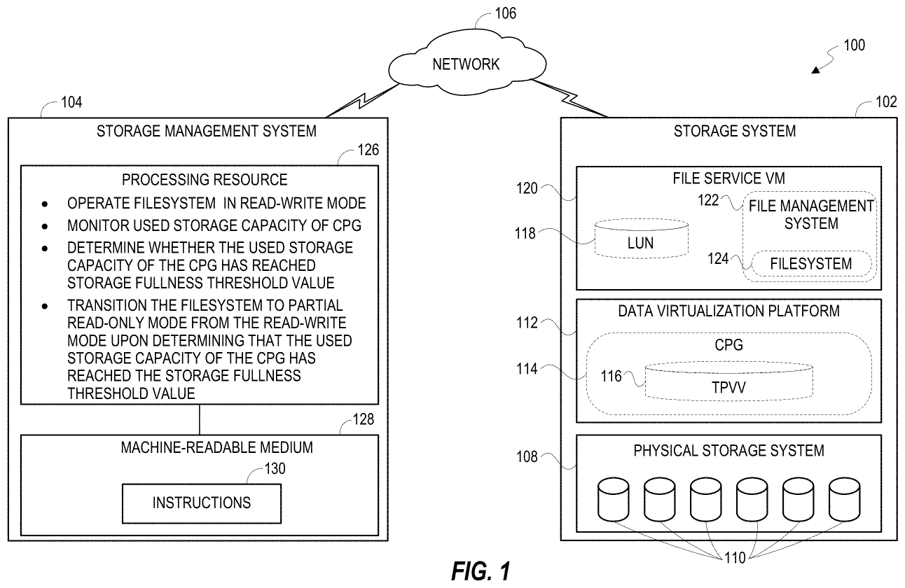

Referring now to drawings, in FIG. 1, an example system 100 is depicted, in accordance with an example. The system 100 may include a storage system 102 and a storage management system 104. The storage management system 104 may be coupled to the storage system 102 via a network 106. In some example configurations, the storage management system 104 and the storage system 102 may be disposed at remote locations from each other, for example, in different enclosures, in different rooms, in different buildings, in different cities, or in different countries. Whereas, in certain example configurations, both the storage management system 104 and the storage system 102 may be disposed in a close proximity of each other, for example, in a common IT infrastructure such as an enclosure or a rack.

The network 106 may be a medium that interconnects the storage management system 104 and the storage system 102 with each other. Examples of the network 106 may include, but are not limited to, an Internet Protocol (IP) or non-IP-based local area network (LAN), wireless LAN (WLAN), metropolitan area network (MAN), wide area network (WAN), a cellular communication network, and the Internet. Communication over the network 106 may be performed in accordance with various communication protocols such as, but not limited to, Transmission Control Protocol and Internet Protocol (TCP/IP), User Datagram Protocol (UDP), IEEE 802.11, and/or cellular communication protocols over communication links 111. The communication over the network 106 may be enabled via a wired (e.g., copper, optical communication, etc.) or wireless (e.g., Wi-Fi, cellular communication, satellite communication, Bluetooth, etc.) communication technologies. In some examples, the network 106 may be enabled via private communication links including, but not limited to, communication links established via Bluetooth, cellular communication, optical communication, radio frequency communication, wired (e.g., copper), and the like. In some examples, the private communication links may be direct communication links between the storage system 102 and the storage management system 104.

The storage system 102 may include any electronic device capable of storing data, processing data, and/or communicating data with external devices over the network 106. Examples of the storage system 102 may include, but are not limited to, a server, a storage device, a network switch, a router, a mobile communication device, a desktop computer, a portable computer, or combinations thereof. In some examples, the storage system 102 may be a converged or a hyper-converged storage system. The storage system 102 may be implemented as a storage blade, for example. Although not shown, the storage system 102 may include one or more processing resources to process the data during operation. For illustration purposes, the system 100 of FIG. 1 is shown to include a single storage system 102. As will be appreciated, the system 100 having more than one such storage systems that may be managed by the storage management system 104 is also envisioned, without limiting the scope of the present disclosure.

In some examples, the storage system 102 may include a physical storage 108 including one or more physical storage devices 110. Examples of the physical storage devices 110, but are not limited to, a random access memory (RAM), a read-only memory (ROM), an electrically erasable programmable read-only memory (EEPROM), a flash memory, a hard disk drive, solid state drive (SSD), etc. During operation of the storage system 102, data may be physically stored in the physical storage devices 110.

In some examples, the storage system 102 may also implement a data virtualization platform 112. The data virtualization platform 112 may abstract aspects (e.g., addressing, configurations, etc.) of the physical storage 108, into a virtual storage, for example as one or more virtual volumes. The data virtualization platform 112 may also provide data services such as deduplication, compression, replication, and the like. In some examples, the data virtualization platform 112 may be enabled via a hypervisor (not shown). The hypervisor may be a computer program, firmware, or a hardware that may facilitate hosting of multiple operating system instances and/or virtual volumes on a common processing resource. Each operating system instance installed on the hypervisor may be referred to as a virtual machine.

The physical storage devices 110 may be divided in multiple chunklets (not shown). In certain examples, in the data virtualization platform 112, one or more logical disks (not shown) may be created from groups of such chunklets. In a logical disk, the chunklets may be arranged as rows of redundant array of independent disks (RAID) sets. Furthermore, the logical disks may be pooled together in a common provisioning group (CPG) 114. For example, the CPG 114 may provide a pool of logical disks for creating several virtual volumes. Accordingly, virtual volumes of varying storage capacity may be created using a storage space defined by the CPG 114. In some examples, the CPG 114 may be any possible mechanism to represent a set of physical storage devices 110 and provision one or more volumes from one or more of the physical storage devices 110. Examples of the virtual volumes that can be created using the CPG 114 may include, but are not limited to, a fully-provisioned virtual volume (FPVV) and a thinly-provisioned virtual volume (TRVV). An FPVV of a predetermined fixed storage size, when created, may occupy the predetermined fixed storage size from the CPG 114 immediately upon creation. Whereas, a TRVV of a certain storage size, when created, may not occupy the certain storage space upon creation. In fact, a storage space may be allocated to such TPVV as needed based on the utilization of such TRVV.

In the data virtualization platform 112 shown in FIG. 1, an example TPVV 116 may be defined using the CPG 114. In some examples, the TPVV 116 may be defined such that a storage capacity allotted to the TPVV 116 may be larger than a total storage capacity of the CPG 114. The total storage capacity of the CPG 114 may be equal to a storage space provided by the physical storage 108 which in-turn may be a sum of storage space provided by all physical storage devices 110 of the physical storage 108. In some examples, the virtual volumes may be exposed to accessing entities, such as, virtual machines, operating systems, and/or applications as a logical unit number (LUN). For example, the TPVV 116 may be exposed to a file-service virtual machine (VM) 120 as a LUN 118. As such, the LUN 118 may represent the TPVV 116 for the file-service VM 120. Accordingly, the LUN 118 may map the filesystem 124 to the TPVV 116. Although, one TPVV (e.g., the TPVV 116) is shown in FIG. 1, more than one TPVVs may also be defined using the CPG 114. Further, such TPVVs may be exposed to the file-service VM 120 as multiple LUNs.

The file-service VM 120 may be hosted on the storage system 102 via the hypervisor, for example. In the example of FIG. 1, the file-service VM 120 may present a file management system 122 to various clients (not shown). The file management system 122 may facilitate file management operations and may allow the clients to access the virtual volume (e.g., the TPVV 116) for various file storage applications using one or more file access protocols, such as, Server Message Block (SMB), Network File system (NFS), and File Transfer Protocol (FTP), and Object Access API protocols such as Representational State Transfer (REST) Application Programming Interface (API). To provide such access to the virtual volume, the file management system 122 may implement one or more of a filesystem 124, Virtual File Server (VFS) (not shown), File Stores (FS) (not shown), and File Shares (not shown).

The filesystem 124 may control how files are stored and retrieved from an underlying virtual volume (e.g., the TPVV 116 represented by the LUN 118). The filesystem 124 may be transparently constructed from one or multiple virtual volumes, for example, the TPVV 116, and may be a unit for replication and disaster recovery for the file management system 122. The VFS may be a server which presents virtual IP addresses to clients, participates in user authentication services and may have properties for user or group quota management, file lock policies, and/or antivirus policies. Certain file management tasks and policy decisions may be made at the VFS level. Further, the FS may represent a slice of the VFS and filesystem 124 at which snapshots may be taken, capacity quota management may be performed, and file lock policies and antivirus scan service policies may be customized. The file shares may provide file level access to the clients via file access protocols, e.g., SMB, NFS, FTP, REST API, subject to the share permissions applied to them. Multiple file shares may be created in a given file store and at different directory levels within the given file store.

In certain configurations of file management systems and as shown in FIG. 1, the filesystem 124 may be defined using the TPVV 116 as represented by the LUN 118. In such file management systems (e.g., the file management system 122) that are defined using the TPVV 116, the clients accessing the file management system 122 may not have visibility of a used capacity of the underlying CPG 114. In traditional approaches, when the underlying CPG 114 runs-out of storage space, alerts may be issued to the clients and the filesystem may be deactivated or transitioned to a read-only mode. In the presently contemplated approach, the system 100 of FIG. 1 includes the storage management system 104 that may manage write modes of the filesystem 124 in such a way that data unavailability (DU) events may be minimized or avoided when the underlying CPG 114 runs-out of storage space.

The storage management system 104 may be coupled to the storage system 102 via the network 106. In some examples, the storage management system 104 may be implemented as physical computing device. In some other examples, the storage management system 104 may be hosted on a computing device as a virtual machine, a container, or a containerized application which may utilize resources (e.g., processing power and/or storage capacity) of the host computing device. The container or containerized application may be located on a single host computing device or distributed across multiple computing devices. In certain examples, the storage management system 104 may be an application running on a storage system similar to the storage system 102. In some other examples, the storage management system 104 may be an application running on the storage system 102. In such a configuration, the network 106 may not be required.

In some examples, as depicted in FIG. 1, the storage management system 104 may include a processing resource 126 and a machine-readable medium 128. In an instance, where the storage management system 104 may be implemented as a physical computing device, the processing resource 126 and the machine-readable medium 128 may represent physical elements within the storage management system 104. Alternatively, in an instance, where the storage management system 104 is implemented as a virtual machine, a container, or as an application, the processing resource 126 and the machine-readable medium 128 may respectively represent a processing resource and a machine-readable medium of a computing device that hosts such storage management system 104. The term computing device as used herein may refer to any electronic device capable of processing and/or manipulating data and may have a processing resource to perform such operations. Various examples of such computing device may include, but are not limited to, a desktop computer, a laptop, a smartphone, a server, a computer appliance, a workstation, a storage system, or a converged or hyper-converged system, and the like.

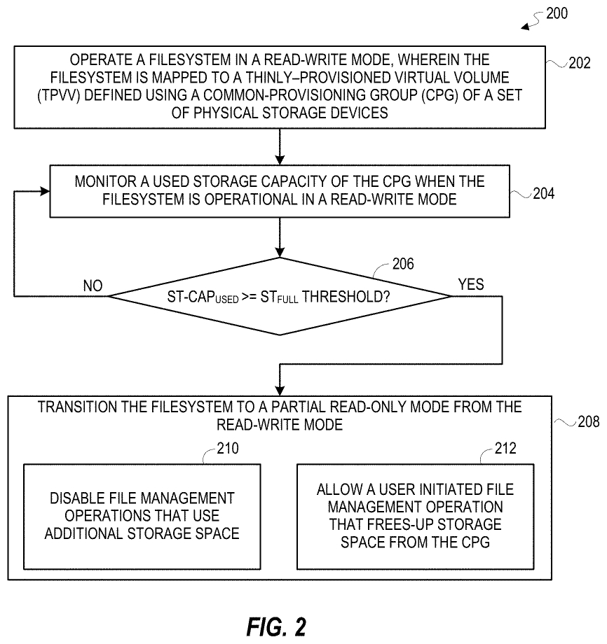

The machine-readable medium 128 may be any electronic, magnetic, optical, or other physical storage device that may store data and/or executable instructions, for example, instructions 130. Therefore, the machine-readable medium 128 may be, for example, Random Access Memory (RAM), an Electrically Erasable Programmable Read-Only Memory (EEPROM), a storage drive, a flash memory, a Compact Disc Read Only Memory (CD-ROM), and the like. The machine-readable medium 128 may be non-transitory. As described in detail herein, the machine-readable medium 128 may be encoded with executable instructions 130 for performing one or more methods, for example, methods described in FIGS. 2, 3, and 4.

The processing resource 126 may be a physical device, for example, one or more central processing unit (CPU), one or more semiconductor-based microprocessors, one or more graphics processing unit (GPU), application-specific integrated circuit (ASIC), a field programmable gate array (FPGA), other hardware devices capable of retrieving and executing of the instructions 130 stored in the machine-readable medium 128, or combinations thereof. The processing resource 126 may fetch, decode, and execute the instructions 130 stored in the machine-readable medium 128 to manage the storage system 102, more particularly, to manage write mode of the filesystem 124. As an alternative or in addition to executing the instructions 130, the processing resource 126 may include at least one integrated circuit (IC), control logic, electronic circuits, or combinations thereof that include a number of electronic components for performing the functionalities intended to be performed by the storage management system 104.

In certain examples, the processing resource 126 may perform various actions to overcome issues such as the DU events, in accordance with aspects of the present disclosure. During normal operation (i.e., when the CPG 114 is not full), the processing resource 126 may instruct the storage system 102 to operate the filesystem 124 in a read-write mode. When operated in the read-write mode that filesystem 124 may allow various file management operations that can consume and/or free-up space from the CPG 114. As will be understood, in the read-write mode, operations such as adding content to files, adding new files, renaming files, over writing files, deleting files, deleting content within the file, truncating, creating and/or deleting directories, creating and/or deleting snapshots, and the like may be allowed.

As various file management operations are performed on the filesystem 124, data may be written to the physical storage 108 and/or data may be deleted from the physical storage 108. As previously noted, a storage capacity of the CPG 114 may be representative of a storage space provided by the physical storage 108. Depending on the operations performed, a used storage capacity of the CPG 114 may increase or decrease. It may be noted that the CPG 114 may also host other virtual volumes (not shown in FIG. 1) which may also consume the storage space from the physical storage 108. Accordingly, the used storage capacity of the CPG 114 may also vary. The term “used storage capacity of CPG” may refer to an amount of storage space that has been occupied from a total storage space presented by the CPG 114. The total storage space presented by the CPG 114 may be equal to a sum of storage space of all physical storage devices 110 of the physical storage 108. In some examples, the used storage capacity of CPG 114 may be represented as percentage of the total storage space presented by the CPG 114. In some other examples, the used storage capacity of CPG 114 may be represented as storage size in any of Megabytes (MB), Gigabytes (GB), Terabyte (TB), and the like.

The processing resource 126 may monitor the used storage capacity of the CPG 114 when the filesystem 124 is operational in the read-write mode. Further, a check may be performed by the processing resource 126 to determine whether the used storage capacity of the CPG 114 has reached a storage fullness threshold value. The storage fullness threshold value may be indicative of a storage capacity equal to the total storage capacity presented by the CPG 114 to or substantially close to the total storage capacity presented by the CPG 114. As previously noted, in one example, the term “substantially close to” may refer to being within 20% of the total storage capacity. In another example, the term “substantially close to” may refer to being less than the total storage capacity by a predetermined storage capacity. The predetermined storage capacity may be defined by a user or preconfigured. In some examples, the storage fullness threshold value may be defined based on a virtual memory allocated to the file-service VM 120.

In response to determining that the used storage capacity of the CPG 114 has reached the storage fullness threshold value, the processing resource 126 may transition the filesystem 124 to a partial read-only mode from the read-write mode. In the partial read-only mode, in accordance with aspects of the present disclosure, file management operations that use additional storage space may be disabled, however, a user initiated file management operation that frees up at least a portion of storage space from the CPG 114 may be allowed in the filesystem 124. Examples of the user initiated operation that may be allowed in the partial read-only mode may include, but are not limited to, a file delete operation, an operation to delete data within a file, a truncate operation, or combinations thereof. Additional details of these and other operations performed by the storage management system 104 will be described on conjunction with methods described in FIGS. 2-4.

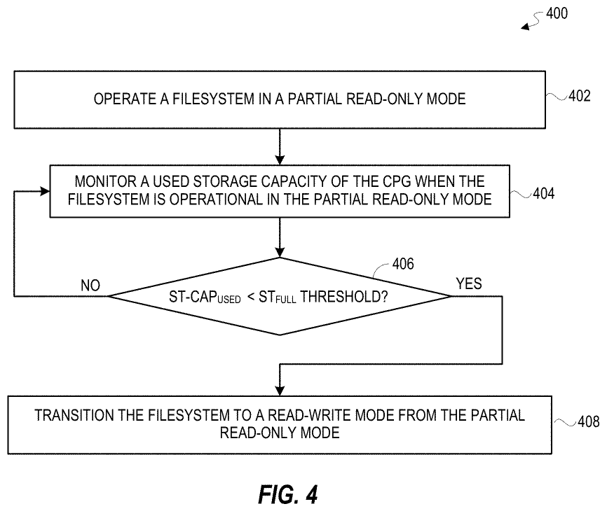

As will be appreciated, the storage management system 104 allows the user initiated file management operations, for example, the file delete operation, the operation to delete data within the file, the truncate operation, etc. when the filesystem 124 is operational in the partial read-only mode. Advantageously, any unused and/or redundant data as determined by the user may be deleted and at least some portion of the storage space from the CPG 114 may be made available. This helps in avoiding DU events for file shares optimize the usage of storage space. Once, certain amount of storage space is made available in the CPG 114, the filesystem 124 may again be transitioned to the read-write mode (see FIG. 4).

Referring now to FIG. 2, a flow diagram depicting a method 200 for managing write modes of a filesystem such as the filesystem 124 is presented, in accordance with an example. The method 200 will be described in conjunction with the system 100 of FIG. 1. As will be appreciated, method steps represented by blocks 202, 204, 206, 208, 210, and 212 (hereinafter collectively referred to as 202-212) may be performed by a processor based system, for example, the storage management system 104. In particular, method at each such method blocks 202-212 may be executed by the processing resource 126 by executing the instructions 130 stored in the machine-readable medium 128.

During normal operation of the file management system 122, at block 202, the storage management system 104 may operate the filesystem 124 of the file management system 122 in a read-write mode. The filesystem 124 may be mapped to the TRVV 116 via the LUN 118. In the read-write mode, various operations including, but not limited to, adding content to files, adding new files, renaming files, over writing files, deleting files, deleting content within the file, truncating, creating and/or deleting directories, creating and/or deleting snapshots, and the like may be allowed on the filesystem 124. As will be understood, depending on the operations performed on the filesystem 124, a used storage capacity of the CPG 114 may increase or decrease.

Further, at block 204, the storage management system 104 may monitor a used storage capacity USED, (ST-CAP_{USED}) of the CPG 114 when the filesystem 124 is operational in the read-write mode. In some examples, the storage management system 104 may monitor the used storage capacity of the CPG 114 on a real-time basis. In some other examples, the storage management system 104 may periodically monitor the used storage capacity of the CPG 114. Further, in certain examples, the storage management system 104 may monitor the used storage capacity of the CPG 114 at random intervals or upon demand from an administrator of the storage management system 104.

Furthermore, at block 206, a check may be performed by the storage management system 104 to determine whether the used storage capacity of the CPG 114 has reached a storage fullness threshold value (ST_{FULL} THRESHOLD). For example, at block 206, the storage management system 104 may compare the used storage capacity of the CPG 114 with the storage fullness threshold value to ascertain whether the used storage capacity of the CPG 114 is greater than or equal to the storage fullness threshold value. In some instances, the used storage capacity being greater than or equal to the storage fullness threshold value may be indicative of the CPG 114 being full or about to become full.

At block 206, if it is determined that the used storage capacity of the CPG 114 has not reached the storage fullness threshold value, the storage management system 104 may continue to monitor the used storage capacity at block 204. However, at block 206, if it is determined that the used storage capacity of the CPG 114 has reached the storage fullness threshold value, the storage management system 104 may perform a method step at block 208. At block 208, the storage management system 104 may transition the filesystem 124 to the partial read-only mode from the read-write mode.

In comparison to conventional read-only mode, the partial read-only mode, in accordance with the present disclosure, does not disable every operations other than reading of files. In particular, as indicated by sub-block 210, the storage management system 104 may disable file management operations that use additional storage space. Further, in accordance with aspects of the present disclosure, in the partial read-only mode, the storage management system 104 may allow a user initiated file management operation that frees up storage space from the CPG 114. Examples of such user initiated file management operations may include, but are not limited to, a file delete operation, an operation to delete data within a file, a truncate operation, a file move operation, or combinations thereof. The term “user initiated file management operations” may include file management operations that are initiated by a user of the storage system 102 and/or storage management system 104. For example, knowing that the used storage capacity of the CPG 114 has reached the storage fullness threshold value, the user may decide to delete certain file and/or directories that are no longer required. Also, the user may decide to move certain files and/or directories to a different storage system so that at some storage space can be released from the CPG 114.

As such, in some examples, the storage space released due to such operations may cause reduction in the used capacity of the CPG 114. Consequently, available storage space in the CPG 114 may increase for further operations/data storage. Accordingly, in some examples, the storage management system 104 may transition the filesystem 124 back to the read-write mode (see FIG. 4).

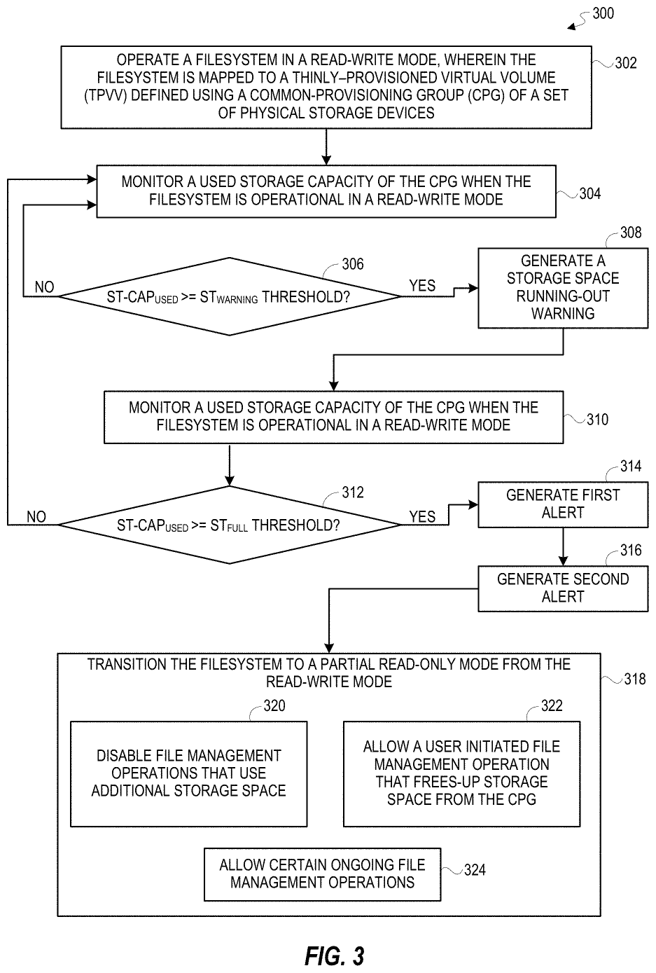

Turning now to FIG. 3, a flow diagram depicting a detailed method 300 for managing write modes of a filesystem such as the filesystem 124 is presented, in accordance with another example. The method 300 will be described in conjunction with the system 100 of FIG. 1. Further, the method 300 of FIG. 3 includes certain blocks that are similar to one or more blocks described in FIG. 2, details of which are not repeated herein for the sake of brevity. By way of example, the blocks 302, 304, 312, 320, and 322 of FIG. 3 are similar to blocks 202, 204, 206, 210, and 212, respectively, of FIG. 2. Also, method steps at various blocks depicted in FIG. 3 may be performed by a processor based system, for example, the storage management system 104. In particular, method at each such method blocks may be executed by the processing resource 126 by executing the instructions 130 stored in the machine-readable medium 128.

As previously noted, at block 302 the storage management system 104 may operate the filesystem 124 in the read-write mode. Also at block 304, the storage management system 104 may monitor the used storage capacity (ST-CAP_{USED}) of the CPG 114. Referring now to block 306, a check may be performed by the storage management system 104 to determine whether the used storage capacity of the CPG 114 has reached a warning threshold value (ST_{WARNING} THRESHOLD). In some examples, the warning threshold value may be smaller than the storage fullness threshold value. The warning threshold value may be set/selected by the user. As such, the warning threshold value may be indicative of a certain amount of storage space left in the physical storage 108. For example, at block 306, the storage management system 104 may compare the used storage capacity of the CPG 114 with the warning threshold value to ascertain whether the used storage capacity is greater than or equal to the warning threshold value. In some instances, the used storage capacity being greater than or equal to the warning threshold value may be indicative of the CPG 114 is going to be full and the certain amount of storage space is available in the physical storage 108.

At block 306, if it is determined that the used storage capacity of the CPG 114 has not reached the warning threshold value, the storage management system 104 may continue to monitor the used storage capacity at block 304. However, at block 306, if it is determined that the used storage capacity of the CPG 114 has reached the warning threshold value, at block 308, the storage management system 104 may generate a warning, for example, storage space running-out warning, to indicate that the CPG 114 is going to be full and the predetermined amount of storage space is available in the physical storage 108. In some examples, the storage space running-out warning may be displayed on a display associated with the storage management system 104 and/or the storage system 102. In some examples, the storage space running-out warning may be presented to the user via an audio, a video, text, or an audio-visual message. In certain examples, a message indicative of the storage space running-out warning may be communicated to the user via a mobile communication device. Based on such storage space running-out warning, the user may consider various file management options to optimize storage space utilization. Further, at block 310, the storage management system 104 may continue to monitor the used storage capacity of the CPG 114 in a similar fashion as described in block 304.

Moreover, the block 312 may be similar to block 206 where the storage management system 104 may perform a check to determine whether the used storage capacity of the CPG 114 has reached the storage fullness threshold value (ST_{FULL} THRESHOLD). At block 312, if it is determined that the used storage capacity of the CPG 114 has not reached the storage fullness threshold value, the storage management system 104 may continue to monitor the used storage capacity at block 304. However, at block 312, if it is determined that the used storage capacity of the CPG 114 has reached the storage fullness threshold value, the storage management system 104 may generate a first alert as indicated by block 314. The first alert may indicate that the CPG 114 is full and filesystem 124 will be transitioned to a partial read-only mode. Further, in some examples, at block 316, the storage management system 104 may generate a second alert. The second alert may indicate that the file management operation that can free-up the storage space from the CPG 114 is permissible in the partial read-only mode. In some examples, the second alert may also include a list of such file management operations that may free-up the storage space from the CPG 114. Accordingly, the user may choose to perform any of such file management operations.

In certain examples, the storage management system 104 may generate a common alert instead of generating two separate alerts, such as, the first and second alerts. Such common alert may provide similar indication as provided by the first and second alerts. As will be appreciated, the first alert, the second alert, or the common alert may be displayed on the display associated with the storage management system 104 and/or the storage system 102. In some examples, the first alert, the second alert, or the common alert may be presented to the user via an audio, video, text, or an audio-visual message. In certain examples, a message indicative of the first alert, the second alert, or the common alert may be communicated to the user via a mobile communication device.

Moreover, at block 318, the storage management system 104 may transition the filesystem 124 to the partial read-only mode from the read-write mode. In addition to method blocks 320, 322 which are respectively similar to blocks 210, 212, the storage management system 104 may also allow certain ongoing file management operations in the partial read-only mode. For example, file management operations that were being performed when the filesystem 124 transitioned to the partial read-only mode and that do not use any additional storage space, may continue to be allowed. Examples of such operations that are continued to be allowed may include, but are not limited to, various write operations, file truncate operations, snapshot delete operations, if it is determined that such operations do not use any additional storage space.

FIG. 4 is a flow diagram depicting a method 400 for managing write modes of the filesystem 124, in accordance with an example. For example, the method 400 may represent various method blocks to transition the filesystem 124 back to the read-write mode when sufficient storage space is available with the CPG 114. Method steps at various blocks depicted in FIG. 4 may be performed by a processor based system, for example, the storage management system 104. In particular, method at each such method blocks may be executed by the processing resource 126 by executing the instructions 130 stored in the machine-readable medium 128.

As such, the method 400 may be performed when the filesystem 124 is operational in the partial read-only mode as indicated by block 402. While the filesystem 124 is operational in the partial read-only mode, at block 404, the storage management system 104 may monitor the used storage capacity of the CPG 114. Further, at block 406, a check may be performed by the storage management system 104 to determine whether the used storage capacity of the CPG 114 is reduced below the storage fullness threshold value (ST_{FULL} THRESHOLD). For example, at block 406, the storage management system 104 may compare the used storage capacity of the CPG 114 with the storage fullness threshold value to ascertain whether the used storage capacity is smaller than the storage fullness threshold value.

At block 406, if it is determined that the used storage capacity of the CPG 114 is not smaller than the storage fullness threshold value, the storage management system 104 may continue to monitor the used storage capacity at block 404. However, at block 406, if it is determined that the used storage capacity of the CPG 114 is reduced below (i.e., smaller than) the storage fullness threshold value, the storage management system 104 may transition the filesystem 124 back to the read-write mode from the partial read-only mode from the read-write mode. In some examples, the used storage capacity of the CPG 114 might have been reduced below the storage fullness threshold value due to one or more allowed/permissible file management operations performed by the user in the partial read-only mode. In certain other examples, the used storage capacity of the CPG 114 might have been reduced below the storage fullness threshold value due to inclusion of one or more additional physical storage devices in the physical storage 108 or by increasing storage space of existing physical storage devices 110.

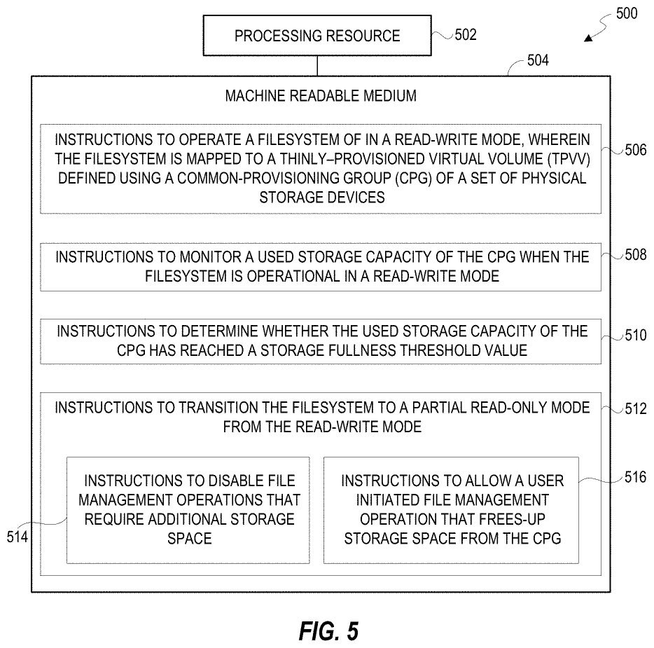

In FIG. 5, a block diagram 500 depicting a processing resource 502 and a machine-readable medium 504 encoded with example instructions to manage write modes of a filesystem, such as, the filesystem 124 is presented, in accordance with an example. The machine-readable medium 504 may be non-transitory and is alternatively referred to as a non-transitory machine-readable medium 504. In some examples, the machine-readable medium 504 may be accessed by the processing resource 502. In some examples, the processing resource 502 may represent one example of the processing resource 126 of the storage management system 104 of FIG. 1. Further, the machine-readable medium 504 may represent one example of the machine-readable medium 128 of the storage management system 104.

The machine-readable medium 504 may be any electronic, magnetic, optical, or other physical storage device that may store data and/or executable instructions. Therefore, the machine-readable medium 504 may be, for example, RAM, an EEPROM, a storage drive, a flash memory, a CD-ROM, and the like. As described in detail herein, the machine-readable medium 504 may be encoded with executable instructions 506-516 for performing one or more methods, for example, the method 200 described in FIG. 2. The instructions 506-516 may represent one example of the instructions 130 of FIG. 1.

The processing resource 502 may be a physical device, for example, one or more CPU, one or more semiconductor-based microprocessor, one or more GPU, ASIC, FPGA, other hardware devices capable of retrieving and executing of the instructions 506-516 stored in the machine-readable medium 504, or combinations thereof. In some examples, the processing resource 502 may fetch, decode, and execute the instructions 506-516 stored in the machine-readable medium 504 to manage write modes of the filesystem 124. In certain examples, as an alternative or in addition to retrieving and executing the instructions 506-516, the processing resource 502 may include at least one IC, other control logic, other electronic circuits, or combinations thereof that include a number of electronic components for performing the functionalities intended to be performed by the storage management system 104.

The instructions 506, when executed, may cause the processing resource 502 to operate the filesystem 124 in a read-write mode. Further, the instructions 508, when executed, may cause the processing resource 502 to monitor a used storage capacity USED, (ST-CAP_{USED}) of the CPG 114 when the filesystem 124 is operational in the read-write mode. Furthermore, the instructions 510, when executed, may cause the processing resource 502 to determine whether the used storage capacity of the CPG 114 has reached a storage fullness threshold value (ST_{FULL} THRESHOLD). Moreover, the instructions 512, when executed, may cause the processing resource 502 to transition the filesystem 124 to a partial read-only mode from the read-write mode upon determining that the used storage capacity of the CPG 114 has reached the storage fullness threshold value. In the partial read-only mode, the instructions 514, when executed, may cause the processing resource 502 to disable file management operations that use additional storage space. Moreover, in the partial read-only mode, the instructions 516, when executed, may cause the processing resource 502 to allow a user initiated file management operation that frees up storage space from the CPG 114.

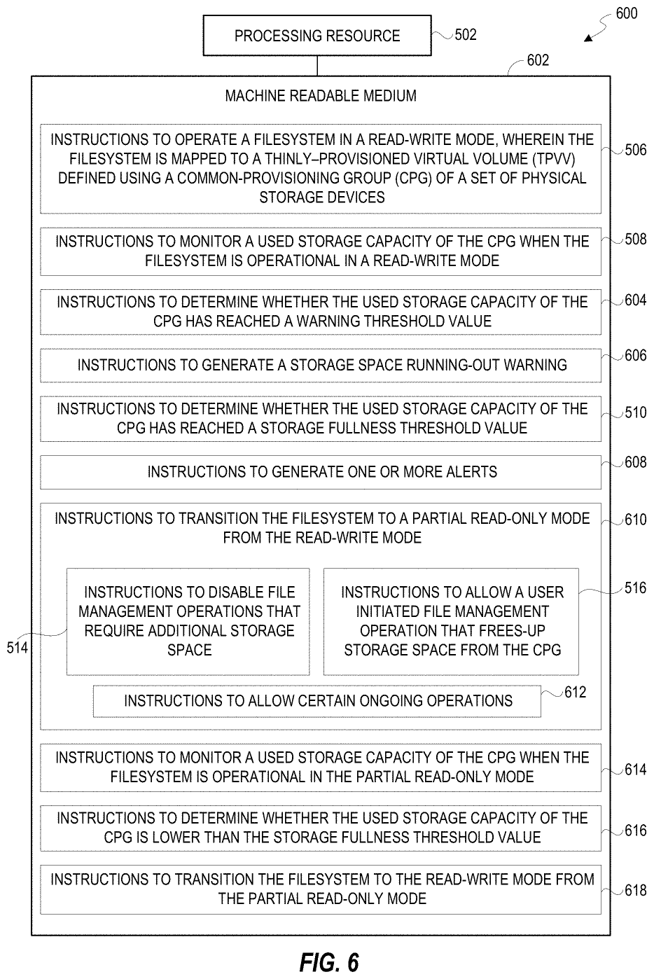

Referring now to FIG. 6, a block diagram 600 depicting a processing resource 502 and a machine-readable medium 602 encoded with example instructions to manage write modes of a filesystem, such as, the filesystem 124 is presented, in accordance with an example. The machine-readable medium 602 may represent one example of the machine-readable medium 504 of FIG. 5. As described in detail herein, the machine-readable medium 602 may be encoded with executable instructions for performing one or more methods, for example, the methods 300 and 400 described in FIGS. 3-4. The instructions stored in the machine-readable medium 602 may represent one example of the instructions 130 of FIG. 1.

As such, the machine-readable medium 602 of FIG. 6 may include certain additional instructions in comparison to the machine-readable medium 504. Description of the instructions 506, 508, 510, 514, and 516 is not repeated herein.

Instructions 604, when executed, may cause the processing resource 502 to determine whether the used storage capacity USED, (ST-CAP_{USED}) of the CPG has reached a warning threshold value (ST_{WARNING} THRESHOLD) smaller than the storage fullness threshold value (ST_{FULL} THRESHOLD). Further, instructions 606, when executed, may cause the processing resource 502 to generate a storage space running-out warning in response to determining that the used storage capacity of the CPG 114 has reached the warning threshold value. Furthermore, instructions 608, when executed, may cause the processing resource 502 to generate one or more alerts (e.g., the first alert and the second alert) in response to determining that the used capacity of the CPG 114 has reached the storage fullness threshold value. The one or more alerts indicate that the CPG 114 is full and the filesystem 124 is transitioning to the partial read-only mode, and the file management operation that frees up the storage space from the CPG 114 is permissible in the partial read-only mode.

Moreover, instructions 610, when executed, may cause the processing resource 502 to transition the filesystem 124 to the partial read-only mode from the read-write mode upon determining that the used storage capacity of the CPG 114 has reached the storage fullness threshold value. In addition to the instructions 514, 516, in the partial read-only mode, the machine-readable medium 602 may include instructions 612. The instructions 612, when executed, may cause the processing resource 502 to allow one or more file management operations that are ongoing while the filesystem 124 is transitioned to the partial read-only mode. The one or more such ongoing file management operations do not use additional storage space.

In some examples, instructions 614, when executed, may cause the processing resource 502 to monitor the used storage capacity of the CPG 114 when the filesystem 124 is operational in the partial read-only mode. Further, instructions 616, when executed, may cause the processing resource 502 to determine whether the used storage capacity USED, (ST-CAP_{USED}) of the CPG 114 is lower than the storage fullness threshold value (ST_{FULL} THRESHOLD) (see FIG. 4). Moreover, instructions 618, when executed, may cause the processing resource 502 to transition the filesystem 124 back to the read-write mode from the partial read-only mode.

As will be appreciated, the storage management system 104 allows the user initiated file management operations, for example, the file delete operation, the operation to delete data within the file, the truncate operation, etc. when the filesystem 124 is operational in the partial read-only mode. Advantageously, any unused and/or redundant data as determined by the user may be deleted and at least some portion of the storage space from the CPG 114 may be made available. This helps in avoiding DU events for file shares optimize the usage of storage space. Once, certain amount of storage space is made available in the CPG 114, the filesystem 124 may again be transitioned to the read-write mode.

While certain implementations have been shown and described above, various changes in form and details may be made. For example, some features, functions, and/or formulas/equations that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

What is claimed is:

1. A method comprising:
operating, by a processor based system, a filesystem in a read-write mode, wherein the filesystem is mapped to a thinly-provisioned virtual volume (TPVV) defined using a common-provisioning group (CPG) of a set of physical storage devices;
monitoring, by the processor based system, a used storage capacity of the CPG when the filesystem is operational in the read-write mode;
determining, by the processor based system, whether the used storage capacity of the CPG has reached a storage fullness threshold value; and
transitioning, by the processor based system, the filesystem to a partial read-only mode from the read-write mode upon determining that the used storage capacity of the CPG has reached the storage fullness threshold value, wherein transitioning the filesystem to the partial read-only mode comprises disabling file management operations that use additional storage space, and allowing a user initiated file management operation that frees up storage space from the CPG.

2. The method of claim 1, wherein a defined storage capacity of the TPVV is greater than a total storage capacity of the CPG.

3. The method of claim 1, wherein the user initiated file management operation that frees up the storage space from the CPG comprises one or more of a file delete operation, an operation to delete data within a file, a truncate operation, or a file move operation.

4. The method of claim 1, further comprising:
determining, by the processor based system, whether the used storage capacity of the CPG has reached a warning threshold value smaller than the storage fullness threshold value; and
generating, by the processor based system, a storage space running-out warning in response to determining that the used storage capacity of the CPG has reached the warning threshold value.

5. The method of claim 1, further comprising generating a first alert in response to determining that the used capacity of the CPG has reached the storage fullness threshold value, wherein the first alert indicates that the CPG is full and filesystem is transitioning to the partial read-only mode.

6. The method of claim 1, further comprising generating, by the processor based system, a second alert in response to determining that the used capacity of the CPG has reached the storage fullness threshold value, wherein the second alert indicates that the file management operation that frees up the storage space from the CPG is permissible in the partial read-only mode.

7. The method of claim 1, further comprising allowing, in the partial read-only mode, one or more file management operations that are ongoing while the filesystem is transitioned to the partial read-only mode, wherein the one or more file management operations do not use additional storage space.

8. The method of claim 1, further comprising:
monitoring, by the processor based system, the used storage capacity of the CPG when the filesystem is operational in the partial read-only mode;
determining, by the processor based system, whether the used storage capacity of the CPG is lower than the storage fullness threshold value; and
transitioning, by the processor based system, the filesystem to the read-write mode from the partial read-only mode.

9. A storage management system, comprising:
a machine-readable medium storing executable instructions;
a processing resource operatively coupled to the machine-readable medium, wherein the processing resource executes the instructions to:
operate a filesystem in a read-write mode, wherein the filesystem is mapped to a thinly-provisioned virtual volume (TPVV) defined using a common-provisioning group (CPG) of a set of physical storage devices;
monitor a used storage capacity of the CPG when the filesystem is operational in the read-write mode;
determine whether the used storage capacity of the CPG has reached a storage fullness threshold value; and
transition the filesystem to a partial read-only mode from the read-write mode upon determining that the used storage capacity of the CPG has reached the storage fullness threshold value, wherein to transition the filesystem to the partial read-only mode, the processing resource is to disable file management operations that use additional storage space, and allow a user initiated file management operation that frees up storage space from the CPG.

10. The storage management system of claim 9, wherein a defined storage capacity of the TRVV is greater than a total storage capacity of the CPG, wherein the TPVV defined on the set of the physical storage devices is hosted on a computing node coupled to the storage management system over a network.

11. The storage management system of claim 9, wherein the user initiated file management operation that frees up the storage space from the CPG comprises one or more of a file delete operation, an operation to delete data within a file, a truncate operation, or a file move operation.

12. The storage management system of claim 9, wherein the processing resource further:
determines whether the used storage capacity of the CPG has reached a warning threshold value smaller than the storage fullness threshold value; and
generates a storage space running-out warning in response to determining that the used storage capacity of the CPG has reached the warning threshold value.

13. The storage management system of claim 9, wherein the processing resource further generates a first alert in response to determining that the used capacity of the CPG has reached the storage fullness threshold value, wherein the first alert indicates that the CPG is full and filesystem is transitioning to the partial read-only mode.

14. The storage management system of claim 9, wherein the processing resource further generates a second alert in response to determining that the used capacity of the CPG has reached the storage fullness threshold value, wherein the second alert indicates that the file management operation that frees up the storage space from the CPG is permissible in the partial read-only mode.

15. The storage management system of claim 9, wherein the processing resource allows, in the partial read-only mode, one or more file management operations that are ongoing while the filesystem is transitioned to the partial read-only mode, wherein the one or more file management operations do not use additional storage space.

16. The storage management system of claim 9, wherein the processing resource further:
monitors the used storage capacity of the CPG when the filesystem is operational in the partial read-only mode;
determines whether the used storage capacity of the CPG is lower than the storage fullness threshold value; and
transitions the filesystem to the read-write mode from the partial read-only mode.

17. A non-transitory machine-readable medium storing instructions executable by a processing resource, the instructions comprising:
instructions to operate a filesystem in a read-write mode, wherein the filesystem is mapped to a thinly-provisioned virtual volume (TRVV) defined using a common-provisioning group (CPG) of a set of physical storage devices;
instructions to monitor a used storage capacity of the CPG when the filesystem is operational in the read-write mode;
instructions to determine whether the used storage capacity of the CPG has reached a storage fullness threshold value; and
instructions to transition the filesystem to a partial read-only mode from the read-write mode upon determining that the used storage capacity of the CPG has reached the storage fullness threshold value, wherein transitioning the filesystem to the partial read-only mode comprises disabling file management operations that use additional storage space, and allowing a user initiated file management operation that frees up storage space from the CPG.

18. The non-transitory machine-readable medium of claim 17, further comprising:
instructions to determine whether the used storage capacity of the CPG has reached a warning threshold value smaller than the storage fullness threshold value; and
instructions to generate a storage space running-out warning in response to determining that the used storage capacity of the CPG has reached the warning threshold value.

18. The non-transitory machine-readable medium of claim 17, further comprising instructions to generate one or more alerts in response to determining that the used capacity of the CPG has reached the storage fullness threshold value, wherein the one or more alerts indicate that the CPG is full and filesystem is transitioning to the partial read-only mode, and the file management operation that frees up the storage space from the CPG is permissible in the partial read-only mode.

19. The non-transitory machine-readable medium of claim 17, further comprising instructions to allow, in the partial read-only mode, one or more file management operations that are ongoing while the filesystem is transitioned to the partial read-only mode, wherein the one or more file management operations do not use additional storage space.

20. The non-transitory machine-readable medium of claim 17, further comprising:
instructions to monitor the used storage capacity of the CPG when the filesystem is operational in the partial read-only mode;
instructions to determine whether the used storage capacity of the CPG is lower than the storage fullness threshold value; and
instructions to transition the filesystem to the read-write mode from the partial read-only mode.
